(19) United States
(12) Patent Application Publication
(10) Pub. No.: US 2009/0111416 A1
(43) Pub. Date: Apr. 30, 2009

(54) INTERMODULATION DISTURBANCE DETECTING CIRCUIT

(75) Inventor: Kazuhisa Ishiguro, Ota-shi (JP)

Correspondence Address: Connolly Bove Lodge & Hutz LLP;Suite 1100, 1875 Eye Street, NW, Washington, DC, 20006, US

(73) Assignee: Niigata Seimitsu Co., Ltd., Jyoetsu-shi (JP)

(21) Appl. No.: 12/262,470

(22) Filed: Oct. 31, 2008

(30) Foreign Application Priority Data
Oct. 31, 2007 (JP) 2007-283608

(51) Int. Cl. H04B 1/10

(52) U.S. Cl. 455/295

(57) ABSTRACT

There are provided a frequency converting circuit 21 for inputting a broadband IF signal which includes a disturbing wave and carrying out a frequency conversion with an oscillating signal having a frequency of a desirable wave, and outputting a signal including a sum frequency component of a frequency component of a disturbing wave which is included in the IF signal and a frequency component of a desirable wave of the oscillating signal and a difference frequency component therebetween, and a low-pass filter 22 for attenuating the sum frequency component to output a signal of the difference frequency component, and a presence of an intermodulation disturbance is detected based on a frequency relationship between two difference frequency components output from the low-pass filter 22. Consequently, it is possible to easily detect the intermodulation disturbance irrespective of a level of a received signal or a desirable wave included therein without carrying out a processing for amplitude modulating the received signal.

### FIELD OF THE INVENTION

The present invention relates to an intermodulation disturbance detecting circuit and more particularly to a circuit for detecting an intermodulation disturbance occurring when two disturbing waves are input to a wireless communicating apparatus such as a radio receiver.

### DESCRIPTION OF THE RELATED ART

A wireless communicating apparatus such as a radio receiver is usually provided with an AGC (Automatic Gain Control) circuit for controlling a gain of a received signal. An RF (Radio Frequency) AGC circuit to be provided in a radio frequency stage controls a quantity of attenuation in an antenna damping circuit or a gain of an LNA (Low Noise Amplifier) or the like corresponding to a level of a received signal which is input.

More specifically, a general RF AGC circuit is not operated when a level (an electric field strength) of a received signal is not greater than a threshold, and does not reduce the gain of the received signal. However, when a signal having a strong electric field is input to an antenna so that the electric field strength exceeds the threshold, the RF AGC circuit is operated to reduce the gain of the received signal, thereby preventing an excessive power from being applied to the wireless communicating apparatus.

In some cases, the received signal includes a disturbing wave in addition to a desirable wave. In this case, it is desirable to set an optimum gain for the desirable wave and the disturbing wave, for example, to optimally control the gain of the received signal in order to suppress the disturbing wave without reducing a receiving sensitivity of the desirable wave. For this purpose, a level of the whole received signal is not simply detected but a level of the desirable wave and that of the disturbing wave are to be detected respectively to control the gain of the received signal based on the respective levels thus detected.

However, a single disturbing wave (a 2-signal disturbance having a disturbing wave in addition to a desirable wave) and a plurality of disturbing waves (an intermodulation disturbance having a plurality of disturbing waves in addition to the desirable wave) are both classified as the disturbing wave. An optimum gain control method for a received signal is varied depending on either of the disturbing waves. More specifically, in order to suppress an intermodulation disturbance, it is necessary to cause a quantity of attenuation of the received signal to be larger than that in the case in which the 2-signal disturbance is caused. For this reason, it is necessary to detect whether the intermodulation disturbance is present or not and to carry out a proper gain control corresponding to a result of the detection.

Conventionally, various method have been proposed as the method of detecting whether the intermodulation disturbance is present or not (for example, see Patent Document 1 to 3).

[Patent Document 1] Japanese Laid-Open Patent Publication No. 5-335855

[Patent Document 2] Japanese Laid-Open Patent Publication No. 10-285062

[Patent Document 3] Japanese Laid-Open Patent Publication No. 6-232771

In the Patent Document 1, a change in an output of an S meter for a variation in a quantity of attenuation of a received signal is checked to decide whether an intermodulation disturbance is present or not. In case of an ordinary signal, when the quantity of attenuation of the received signal is varied, an output signal level of the S meter is correspondingly changed in a ratio of one to one. However, in the case in which a signal occurred by the intermodulation disturbance is input to the S meter, the level is changed in a ratio of one of a quantity of attenuation of the received signal to three of the output of the S meter. Accordingly, by checking the change in the output of the S meter with respect to the variation in the quantity of attenuation of the received signal, it is possible to decide whether the intermodulation disturbance is present or not.

In the Patent Document 2, a difference between a frequency of a desirable station and a frequency of another preset broadcasting station is obtained and whether a frequency relationship causing the intermodulation disturbance is set is detected depending on the difference. More specifically, when the received signal has a signal having two frequencies f₁ and f₂, a signal having a frequency of (2f₂−f₁) is generated in a processing process. In some cases in which the two frequencies f₁ and f₂ are comparatively close to each other, a signal generated by the intermodulation has an almost equal frequency to the frequency of another broadcasting station. This appears as the intermodulation disturbance. In the Patent Document 2, it is detected whether a frequency relationship causing the intermodulation disturbance is set.

In the Patent Document 3, an amplitude modulation with an auxiliary signal is performed to a received signal and a sideband positioned on an outside of an effective frequency range is generated in this case to compare an amplitude of at least one sideband generated by the amplitude modulation with an amplitude of a carrier fa received in an intermediate frequency signal. When two broadcasting stations are placed in a position of a tuning frequency, for example, 2f₂−f₁=fa, a difference in the amplitude between the carrier and the additional sideband is smaller than that in a broadcasting station received without the intermodulation. Therefore, the presence of the intermodulation disturbance is detected depending on whether a deviation is caused to occur from a value of a ratio determined by a degree of modulation in the amplitude modulation through the auxiliary signal.

### DISCLOSURE OF THE INVENTION

In the technique described in the Patent Document 1, however, the condition wherein the S meter has an attenuation of one with respect to an attenuation of one in an RF stage in receipt of only the desirable wave having no intermodulation disturbance and has an attenuation of three with respect to an attenuation of one in the RF stage in occurrence of the intermodulation disturbance is realized when the desirable wave has a sufficiently smaller level than the disturbing wave. For this reason, there is a problem in that the technique described in the Patent Document 1 cannot be applied to all of the levels of the desirable wave and the intermodulation disturbance can be detected depending on the circumstances.

In the technique described in the Patent Document 2, a sensitivity of RF-AGC is increased in a frequency relationship in which two preset broadcasting stations occur the intermodulation disturbance in a receiver having an auto memory mode. More specifically, it is not detected whether the intermodulation disturbance is actually occurred in the received signal or not. For this reason, the technique described in the Patent Document 2 has a problem in that the presence/absence of the intermodulation disturbance cannot be detected for an arbitrary received signal.

In the technique described in the Patent Document 3, furthermore, a received signal is changed by 100 dB or more. For this reason, the amplitude modulation cannot easily be applied to this range. In the technique described in the Patent Document 3, therefore, there is a problem in that it is hard to detect the presence of the intermodulation disturbance for a received signal having a great receiving strength of 100 dB or more.

In order to solve the problems, it is an object of the present invention to enable an easy detection of an intermodulation disturbance irrespective of a level of a received signal or a desirable wave included therein.

In order to attain the object, in the present invention, there are provided a frequency converting portion for inputting an intermediate frequency signal to carry out a frequency conversion with an oscillating signal having a frequency of a desirable wave, a low-pass filter or a band-pass filter connected to an output stage of the frequency converting portion, and a detecting portion for detecting a presence/absence of an intermodulation disturbance based on a frequency relationship of a signal output from the low-pass filter or the band-pass filter.

In the present invention having the structure described above, it is assumed that the intermediate frequency signal to be input to the frequency converting portion includes a disturbing wave. In this case, the frequency of the disturbing wave is converted with the frequency of the desirable wave through the frequency converting portion so that a signal including a sum frequency component of the frequency component of the disturbing wave and the frequency component of the desirable wave and a difference frequency component therebetween is output. The sum frequency component is removed by the low-pass filter or the band-pass filter so that only the difference frequency component is extracted. At this time, on the assumption that two disturbing waves are included in the intermediate frequency signal input to the frequency converting portion, two difference frequency components are included in the signal output from the low pass filter or the band-pass filter. It is possible to detect the presence/absence of the intermodulation disturbance depending on whether the two difference frequency components have a frequency relationship causing the intermodulation disturbance or not.

In the present invention, thus, the difference frequency component which is different from the frequency of the desirable wave is extracted by the frequency converting portion and the low-pass filter or the band-pass filter to detect the presence/absence of the intermodulation disturbance. Therefore, it is possible to detect the intermodulation disturbance irrespective of the level of the desirable wave. In the present invention, moreover, a processing for amplitude modulating a received signal is not required and there is no limitation that it is hard to apply the amplitude modulation to the received signal having a great receiving strength. According to the present invention, consequently, it is possible to easily detect the intermodulation disturbance irrespective of the level of the received signal or the desirable wave included therein.

### BRIEF DESCRIPTION OF THE DRAWINGS

FIG. 1 is a diagram showing an example of a structure of a detecting circuit constituting a part of an intermodulation disturbance detecting circuit according to the present embodiment,

FIG. 2 is a diagram showing an example of a structure of a radio receiver applying the intermodulation disturbance detecting circuit according to the present embodiment,

FIG. 3 is a table showing an example of first table information according to the present embodiment, and

FIG. 4 is a table showing an example of second table information according to the present embodiment.

### BEST MODE FOR CARRYING OUT THE INVENTION

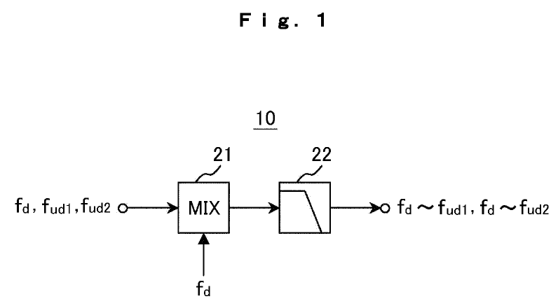

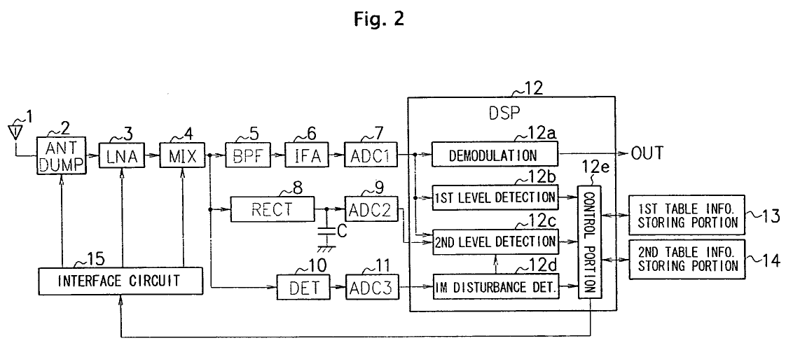

An embodiment according to the present invention will be described below with reference to the drawings. FIG. 1 is a diagram showing an example of a structure of a detecting circuit constituting a part of an intermodulation disturbance detecting circuit according to the present embodiment. FIG. 2 is a diagram showing an example of a structure of a radio receiver applying the intermodulation disturbance detecting circuit according to the present embodiment.

As shown in FIG. 2, a radio receiver according to the present embodiment is constituted to include an antenna 1, an antenna damping circuit 2, an LNA 3, a frequency converting circuit 4, a BPF 5, an IF amplifier 6, a first A/D converting circuit 7, a rectifying circuit 8, a second A/D converting circuit 9, a detecting circuit 10, a third A/D converting circuit 11, a DSP 12, a first table information storing portion 13, a second table information storing portion 14 and an interface circuit 15. These structures (excluding the antenna 1) are integrated into a single semiconductor chip through a CMOS (Complementary Metal Oxide Semiconductor), for example.

The antenna damping circuit 2 controls a radio frequency signal received by the antenna 1 to have a degree of attenuation which is variably set in response to a control signal supplied from the interface circuit 15. The LNA 3 amplifies the RF signal passing through the antenna damping circuit 2 with a low noise. A gain of the LNA 3 is controlled in response to a control signal supplied from the interface circuit 15.

The signal amplified by the LNA 3 is supplied to the frequency converting circuit 4. The frequency converting circuit 4 mixes the RF signal supplied from the LNA 3 with a local oscillating signal supplied from a local oscillating circuit which is not shown, and carries out a frequency conversion to generate and output an intermediate frequency signal (an IF signal). The frequency converting circuit 4 also has a gain control function and the gain is controlled in response to the control signal supplied from the interface circuit 15. The BPF 5 carries out a band limitation for the IF signal supplied from the frequency converting circuit 4 and extracts an IF signal of a narrow band (narrowband IF signal) including only a desirable wave frequency.

The IF amplifier 6 amplifies the narrowband IF signal which is output from the BPF 5. The first A/D converting circuit 7 analog-digital converts the IF signal output from the IF amplifier 6. The narrowband digital IF signal which is thus converted into digital data is input to the DSP 12. The DSP 12 includes a demodulating portion 12a, a first level detecting portion 12b, a second level detecting portion 12c, an intermodulation disturbance detecting portion 12d and a control portion 12e as functional structures thereof. The demodulating portion 12a demodulates, into a baseband signal, the narrowband digital IF signal which is input from the first A/D converting circuit 7 and outputs the baseband signal.

The rectifying circuit 8 rectifies an IF signal of a broad band (broadband IF signal) which is output from the frequency converting circuit 4. A smoothing capacitor C is connected to a subsequent stage to the rectifying circuit 8. The second A/D converting circuit 9 analog-digital converts an IF signal converted into a direct current by the rectifying circuit 8 and the smoothing capacitor C. The broadband digital IF signal which is thus converted into the digital data is input to the DSP 12.

The detecting circuit 10 is required for detecting whether an intermodulation disturbance occurs in the RF signal received by the antenna 1 or not, and detects the IF signal in the broadband (including both a desirable wave and a disturbing wave) which is output from the frequency converting circuit 4. As shown in FIG. 1, the detecting circuit 10 according to the present embodiment includes a frequency converting circuit 21 and a low-pass filter 22.

The frequency converting circuit 21 corresponds to the frequency converting portion according to the present invention, and inputs the broadband IF signal from the frequency converting circuit 4 and carries out a frequency conversion with an oscillating signal having a frequency of a desirable wave for the broadband IF signal. Consequently, the frequency converting circuit 21 outputs a signal including a sum frequency component of a frequency component of a disturbing wave which is included in the broadband IF signal and a frequency component of a desirable wave of the oscillating signal and a difference frequency component therebetween.

It is assumed that the broadband IF signal which is to be input to the frequency converting circuit 21 includes a desirable wave (a frequency f_{d}) and two disturbing waves (frequencies f_{ud1}, f_{ud2}) as shown in FIG. 1. In this case, the broadband IF signal is frequency converted with a frequency of a desirable wave. Consequently, a signal including six frequency components of (f_{d}+f_{d}) (f_{d}+f_{ud1}), (f_{d}+f_{ud2}) (|f_{d}−f_{d}|), (|f_{d}−f_{ud1}|) and (|f_{d}−f_{ud2}|) is output from the frequency converting circuit 21. (f_{d}+f_{d}) (f_{d}+f_{ud1}) and (f_{d}+f_{ud2}) are the sum frequency components and (|f_{d}−f_{d}|), (|f_{d}−f_{ud1}|) and (|f_{d}−f_{ud2}|) are the difference frequency components.

The low-pass filter 22 connected to an output stage of the frequency converting circuit 21 attenuates the sum frequency component of the signal output from the frequency converting circuit 21 and extracts the difference frequency component. For example, by setting a cut-off frequency of the low-pass filter 22 into the vicinity of the frequency f_{d} of the desirable wave, it is possible to extract the three difference frequency components of (|f_{d}−f_{d}|), (|f_{d}−f_{ud1}|) and (|f_{d}−f_{ud2}|). Since |f_{d}−f_{d}|=0 (a DC component) is set, it is disregarded in a processing for detecting an intermodulation disturbance which will be described below. It is also possible to provide a capacitor for cutting a DC component between the frequency converting circuit 21 and the low-pass filter 22.

The third A/D converting circuit 11 analog-digital converts the signal output from the detecting circuit 10. A detection signal thus converted into digital data is input to the DSP 12.

The first level detecting portion 12b of the DSP 12 detects a receiving electric field strength (an antenna level of a desirable wave) of a desirable wave frequency included in the RF signal received by the antenna 1 based on a narrowband digital IF signal which is input from the first A/D converting circuit 7. Moreover, the second level detecting portion 12c detects a receiving electric field strength of a disturbing wave frequency (an antenna level of a disturbing wave) included in the RF signal received by the antenna 1 based on the narrowband digital IF signal which is input from the first A/D converting circuit 7 and the broadband digital IF signal which is input from the second A/D converting circuit 9.

Description will be given to a method of detecting the antenna level of the desirable wave and that of the disturbing wave through the DSP 12. First of all, an antenna level VD of the desirable wave can be obtained by a calculation expressed in the following (Formula 1).

VD=VIF0+Grf+Gif (Formula 1)

VIF0: an IF amplifier output level of the desirable wave

Grf: a total gain of an RF stage (the antenna damping circuit 2, the LNA 3, the frequency converting circuit 4)

Gif: a gain of the IF amplifier 6

The IF signal input from the first A/D converting circuit 7 to the DSP 12 is present with a narrow band including only the desirable wave frequency. By detecting a level of the IF signal to be input from the first A/D converting circuit 7 to the DSP 12 through the DSP 12, accordingly, it is possible to easily obtain the IF amplifier output level VIF0 of the desirable wave. Since the total gain Grf of the RF stage is a total of gains controlled by the DSP 12 itself and set to the antenna damping circuit 2, the LNA 3 and the frequency converting circuit 4 through the interface circuit 15, moreover, it is grasped by the DSP 12 itself. Furthermore, the gain Gif of the IF amplifier 6 is controlled (IF-AGC) by the DSP 12 so as not to exceed a maximum input of the first A/D converting circuit 7, which is not shown. Therefore, the DSP 12 grasps the gain Gif of the IF amplifier 6.

On the other hand, the broadband digital IF signal which is input from the second A/D converting circuit 9 to the DSP 12 is present with a broad band including both the desirable wave frequency and the disturbing wave frequency. Therefore, the signal level VAGC is expressed in the following (Formula 2).

VAGC=√((VD(Grf+Gagc)²+(VUD(Grf+Gagc))²)) (Formula 2)

VUD: an antenna level of the disturbing wave

Gagc: a gain of the rectifying circuit 8

When there are two disturbing waves, the level VAGC of the digital IF signal in the broad band is given in accordance with the following (Formula 3). Levels of the two disturbing waves are set to be equal to each other.

VAGC=√{(VD(Grf+Gagc))²+2(VUD(Grf+Gagc))²} (Formula 3)

Since the gain of the rectifying circuit 8 has a fixed value, it is possible to previously grasp the gain in the DSP 12. Therefore if the level VAGC of the broadband digital IF signal and the IF amplifier output level VIF0 of the desirable wave are known from the (Formula 1) to the (Formula 3), it is possible to obtain the antenna level VUD of the disturbing wave. As described above, the DSP 12 can easily obtain the IF amplifier output level VIF0 of the desirable wave by detecting the level of the IF signal which is input from the first A/D converting circuit 7. Moreover, the DSP 12 can easily obtain the level VAGC of the broadband digital IF signal by detecting the level of the IF signal which is input from the second A/D converting circuit 9.

The intermodulation disturbance detecting portion 12d of the DSP 12 corresponds to the detecting portion according to the present invention and detects whether an intermodulation disturbance occurs in the RF signal received by the antenna 1 based on a frequency relationship of a detection signal of the digital IF signal in the broad band which is input from the third A/D converting circuit 11 (a signal having a difference frequency component which is output from the low-pass filter 22). In the present embodiment, the intermodulation disturbance detecting circuit according to the present invention is constituted by the intermodulation disturbance detecting portion 12d and the detecting circuit 10 and third A/D converting circuit 11.

When the received signal has two disturbing waves having the frequencies f_{ud1} and f_{ud2} as described above, a spurious signal having a frequency of (2f_{ud2}−f_{ud1}) is occurred in a processing process. When frequencies of the two disturbing waves are represented by f_{ud1}=f_{d}+Δf and f_{ud2}=f_{d}+2Δf (Δf indicates a channel space of a broadcasting station which is 100 kHz in case of an FM broadcast in Japan, for example), a spurious frequency fₛ is expressed as follows.

fₛ=2f_{ud1}−f_{ud2}=2(f_{d}+Δf)−(f_{d}+2Δf)=f_{d}

As is apparent from the equation, the spurious frequency fₛ is coincident with the frequency f_{d} of the desirable wave. This is an intermodulation disturbance.

On the other hand, assuming that frequencies f_{ud1} and f_{ud2} of the two disturbing waves have a frequency relationship as describe above which causes the intermodulation disturbance for the frequency f_{d} of the desirable wave, the two difference frequency components (|f_{d}−f_{ud1}|) and (|f_{d}−f_{ud2}|) possessed by the detection signal output from the low-pass filter 22 are expressed as follows.

|f_{d}−f_{ud1}|=|f_{d}−(f_{d}+Δf)|=Δf

|f_{d}−f_{ud2}|=|f_{d}−(f_{d}+2Δf)|=2Δf

As is apparent from the equations, two difference frequencies have a difference of Δf.

From the foregoing, the intermodulation disturbance detecting portion 12d can detect whether the intermodulation disturbance occurs in the RF signal received by the antenna 1 or not depending on whether the two difference frequency components included in the signal output from the low-pass filter 22 have a frequency difference of Δf or not. In place of the consideration of the frequency difference, it is also possible to detect the presence/absence of the intermodulation disturbance depending on whether the first difference frequency component of |f_{d}−f_{ud1}| is equal to Δf and the second difference frequency component of |f_{d}−f_{ud2}| is equal to 2Δf or not.

The second level detecting portion 12c obtains the antenna level VUD of the disturbing wave in accordance with the (Equation 2) or the (Equation 3) corresponding to a result of the detection of the intermodulation disturbance detecting portion 12d.

The control portion 12e of the DSP 12 controls the gain of the received signal through the gain control portion in the RF stage (the antenna damping circuit 2, the LNA 3 and the frequency converting circuit 4) by referring to table information (the details of contents will be described below) stored in the first and second table information storing portions 13 and 14 based on the antenna level of the desirable wave detected by the first level detecting portion 12b and that of the disturbing wave detected by the second level detecting portion 12c.

More specifically, the control portion 12e generates control data for controlling the gain in the RF stage by referring to the table information. The control data are output to the interface circuit 15. The interface circuit 15 generates a control signal for controlling the gains of the antenna damping circuit 2, the LNA 3 and the frequency converting circuit 4 and supplies the control signal to the antenna damping circuit 2, the LNA 3 and the frequency converting circuit 4. Consequently, the gain of the received signal in the RF stage is controlled.

The interface circuit 15 includes a decoder for decoding the control data supplied from the control portion 12e and an analog switch controlled to be switched based on an output of the decoder, and controls the gain of the received signal in the RF stage by switching the analog switch. Because of the structure, the analog switch is directly controlled based on the table information stored in the first and second table information storing portions 13 and 14 so that the gain of the RF stage can be controlled digitally.

Next, description will be given to the table information stored in the first and second table information storing portions 13 and 14. The table information according to the present embodiment indicates a correspondence of the antenna level VD of the desirable wave and the antenna level VUD of the disturbing wave which are detected by the DSP 12 to the gain of the received signal which is to be controlled by the gain control portions in the RF stage (the antenna damping circuit 2, the LNA 3 and the frequency converting circuit 4).

The first table information indicates a correspondence of the antenna level VD of the desirable wave and the antenna level VUD of the disturbing wave to the gain of the received signal which is to be controlled by the gain control portion, and a gain distribution is set according to the case in which an intermodulation disturbance does not occur (the case in which a 2-signal disturbance occurs or an intermodulation does not occur even if at least two disturbance waves are present). The second table information is obtained by a correspondence of the antenna level VD of the desirable wave and the antenna level VUD of the disturbing wave to the gain of the received signal which is to be controlled by the gain control portion, and a gain distribution is set according to the intermodulation disturbance.

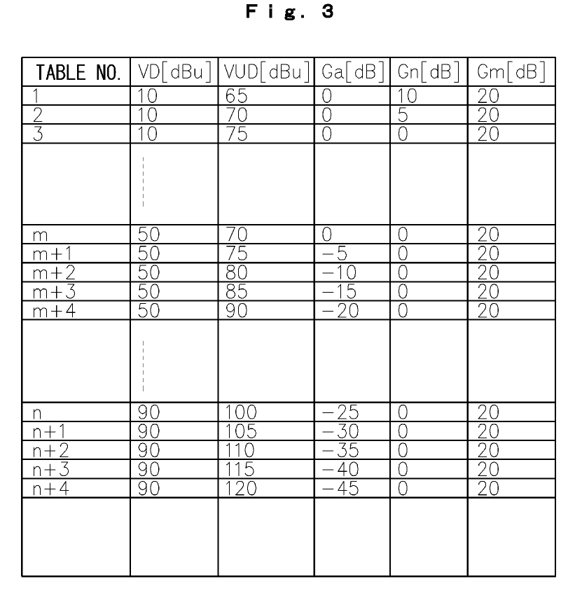

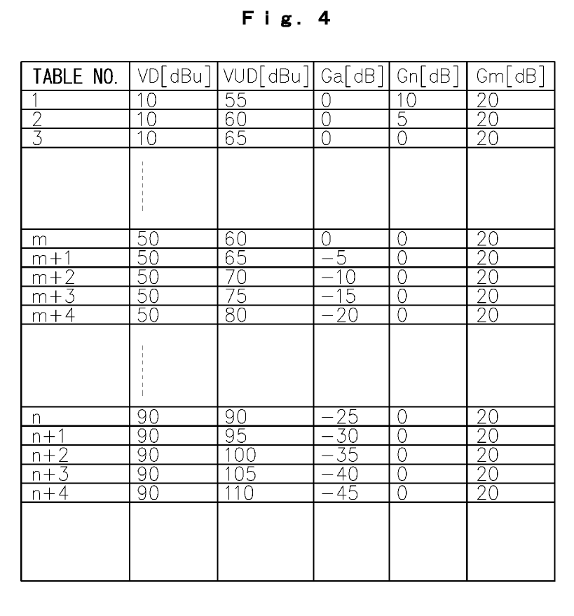

FIG. 3 is a table showing an example of the first table information. FIG. 4 is a table showing an example of the second table information. The control portion 12e sequentially controls a gain Ga of the antenna damping circuit 2, a gain Gn of the LNA 3 and a gain Gm of the frequency converting circuit 4 depending on the antenna level VD of the desirable wave and the antenna level VUD of the disturbing wave based on the first and second table information, thereby improving a occurrence of a distortion of the received signal. Here, the gain Ga of the antenna damping circuit 2 can be variably set within a range of 0 [dB] or less and the gain Gn of the LNA 3 can be variably set within a range of 0 to 20 [dB].

Referring to the first table information shown in FIG. 3, the gain distribution is set to operate the AGC when the antenna level VUD of the disturbing wave is equal to or greater than 65 [dBμ], thereby controlling the gains of the antenna damping circuit 2, the LNA 3 and the frequency converting circuit 4. More specifically, when the antenna level VD of the desirable wave is less than 50 [dBμ], the gain distribution is set to attenuate the received signal through only the LNA 3 irrespective of the antenna level VUD of the disturbing wave in order to avoid a problem of a suppression in a sensitivity. On the other hand, the gain distribution is set to reduce the gain in the antenna damping circuit 2 in addition to the LNA 3 when the antenna level VUD of the disturbing wave is equal to or greater than 75 [dBμ] in the case in which the antenna level VD of the desirable wave is equal to or greater than 50 [dBμ]. The reason is that a quantity of the attenuation is insufficient even through a reduction in the gain of the LNA 3 when the antenna level VUD of the disturbing wave is equal to or greater than 75 [dBμ]. In this case, the antenna level VD of the desirable wave is comparatively high, that is, is equal to or higher than 50 [dBμ]. Therefore, the problem of the suppression in a sensitivity can be lessened.

For example, if the antenna level VD of the desirable wave is 10 [dBμ] and the antenna level VUD of the disturbing wave is 65 [dBμ], the gain Ga of the antenna damping circuit 2, the gain Gn of the LNA 3 and the gain Gm of the frequency converting circuit 4 are set to be Ga=0 [dB], Gn=10 [dB] and Gm=20 [dB], respectively. If a state of a field is changed so that VD=50 [dBμ] and VUD=75 [dBμ] are set, a control is carried out to set the gain into Ga=−5 [dB], Ga=0 [dB] and Gm=20 [dB].

For the first table information shown in FIG. 3, there is created a table determining an optimum gain distribution for each stage depending on the antenna level VD of the desirable wave and the antenna level VUD of the disturbing wave. Consequently, it is possible to control the optimum gain setting through the antenna level VD of the desirable wave and the antenna level VUD of the disturbing wave when the intermodulation disturbance does not occur. Although it is possible to set the optimum gain distribution for each stage depending on the antenna level VD of the desirable wave and the antenna level VUD of the disturbing wave based on a simulation value, the optimum gain distribution can be evaluated and determined by using an IC on which the circuit shown in FIG. 2 is mounted.

Referring to the second table information shown in FIG. 4, the gain distribution is set to operate the AGC when the antenna level VUD of the disturbing wave is equal to or higher than 55 [dBμ], thereby controlling the gains of the antenna damping circuit 2, the LNA 3 and the frequency converting circuit 4. More specifically, a threshold of the antenna level VUD of the disturbing wave which starts the AGC operation is set to be lower than 10 [dBμ] than that (65 [dBμ]) of the first table information. For this reason, if the value of the antenna level VUD of the disturbing wave is equal, the second table information has a larger quantity of the attenuation than the first table information.

Also in the second table information, in the case in which the antenna level VD of the desirable wave is lower than 50 [dBμ] in the same manner as in the first table information, the gain distribution is set to attenuate the received signal through only the LNA 3 irrespective of the antenna level VUD of the disturbing wave in order to eliminate the problem of the suppression in a sensitivity. On the other hand, in the case in which the antenna level VD of the desirable wave is equal to or higher than 50 [dBμ], the gain distribution is set to reduce a gain by the antenna damping circuit 2 in addition to the LNA 3 when the antenna level VUD of the disturbing wave is equal to or higher than 65 [dBμ].

For example, if the antenna level VD of the desirable wave is 10 [dBμ] and the antenna level VUD of the disturbing wave is 65 [dBμ], the gain Ga of the antenna damping circuit 2, the gain Gn of the LNA 3 and the gain Gm of the frequency converting circuit 4 are set to be Ga=0 [dB], Gn=0 [dB] and Gm=20 [dB], respectively. If a state of a field is changed so that VD=50 [dBμ] and VUD=75 [dBμ] are set, a control is carried out to set the gain into Ga=−15 [dB], Ga=0 [dB] and Gm=20 [dB].

For the second table information shown in FIG. 4, there is created a table determining an optimum gain distribution for each stage depending on the antenna level VD of the desirable wave and the antenna level VUD of the disturbing wave. Consequently, it is possible to control the optimum gain setting through the antenna level VD of the desirable wave and the antenna level VUD of the disturbing wave when an intermodulation disturbance occurs. Although it is possible to set the optimum gain distribution for each stage depending on the antenna level VD of the desirable wave and the antenna level VUD of the disturbing wave based on a simulation value, the optimum gain distribution can be finally evaluated and determined by using an IC on which the circuit shown in FIG. 2 is mounted.

Although the gain of the frequency converting circuit 4 is not controlled at all in the examples of FIGS. 3 and 4, it is also possible to first control the gain of the frequency converting circuit 4. The intermodulation disturbance is mainly occurred in the antenna 1 and the LNA 3. Depending on a system structure, however, it is possible to improve the intermodulation disturbance by controlling the gain of the frequency converting circuit 4 when an input level of the desirable wave is low.

The control portion 12e of the DSP 12 controls the control of the gain of the received signal in the RF stage by selectively referring to either of the first and second table information based on the antenna level VD of the desirable wave which is detected by the first level detecting portion 12b and the antenna level VUD of the disturbing wave which is detected by the second level detecting portion 12c, and the presence/absence of the intermodulation disturbance which is detected by the intermodulation disturbance detecting portion 12d. More specifically, the control portion 12e controls the gain of the received signal in the RF stage by referring to the first table information when the intermodulation disturbance is not occurred and referring to the second table information when the intermodulation disturbance is occurred.

As described above in detail, in the present embodiment, the broadband IF signal which includes the frequency of the disturbing wave is input to the frequency converting circuit 21 and the frequency conversion is carried out with the oscillating signal having the frequency of the desirable wave, and the output signal is caused to pass through the low-pass filter 22 to extract the difference frequency component between the frequency of the disturbing wave which is included in the IF signal and the frequency of the desirable wave of the oscillating signal. Based on the frequency relationship of the difference frequency component, the presence/absence of the intermodulation disturbance is detected.

In this case, on the assumption that the IF signal to be input to the frequency converting circuit 21 includes a desirable wave and two disturbing waves and frequencies of the two disturbing waves have a relationship of the intermodulation disturbance having frequency differences of Δf and 2Δf from the frequency of the desirable wave respectively, two difference frequency components possessed by the signal output from the low-pass filter 22 have the frequency difference of Δf. Consequently, it is possible to detect the presence/absence of the intermodulation disturbance depending on whether the two difference frequency components have the frequency difference of Δf or not.

In the present embodiment, thus, the difference frequency component which is different from the frequency of the desirable wave is extracted by the frequency converting circuit 21 and the low-pass filter 22 to detect the presence/absence of the intermodulation disturbance. Therefore, it is possible to detect the intermodulation disturbance irrespective of the level of the desirable wave. In the present embodiment, moreover, a processing for amplitude modulating a received signal is not executed. Therefore, it is possible to easily detect the intermodulation disturbance irrespective of a level of the received signal or the desirable wave included therein.

Although the description has been given to the example in which the intermodulation disturbance detecting circuit according to the present invention is constituted by the detecting circuit 10, the third A/D converting circuit 11 and the intermodulation disturbance detecting portion 12d and the intermodulation disturbance detecting portion 12d is constituted by the DSP 12, the present invention is not restricted thereto.

While the description has been given to the example in which the low-pass filter 22 is used in the output stage of the frequency converting circuit 21 in the embodiment, it is also possible to use a band-pass filter in place of the low-pass filter 22. In this case, the band-pass filter also attenuates the sum frequency component of the signal output from the frequency converting circuit 21, thereby extracting the difference frequency component. For example, by setting a cut-off frequency on a low frequency side of the band-pass filter into a lower frequency than a minimum value to be considered as a value of |f_{d}−f_{ud1}| and setting a cut-off frequency on a radio frequency side of the band-pass filter into the vicinity of the frequency f_{d} of the desirable wave, it is possible to extract the two difference frequency components of |f_{d}−f_{ud1}| and |f_{d}−f_{ud2}|. A DC component of |f_{d}−f_{d}|=0 can be cut even if a capacitor for cutting a DC component is not provided.

In addition, all of the embodiments are only illustrative for a materialization to carry out the present invention and the technical range of the present invention should not be thereby construed to be restrictive. More specifically, the present invention can be carried out in various forms without departing from the spirit or main features thereof.

### INDUSTRIAL APPLICABILITY

The intermodulation disturbance detecting circuit according to the present invention is suitably applied to an automatic gain control apparatus for carrying out an AGC operation in a wireless communicating apparatus such as a radio receiver.

What is claimed is:

1. An intermodulation disturbance detecting circuit comprising:
a frequency converting portion for inputting an intermediate frequency signal converted from a radio frequency received signal to carry out a frequency conversion with an oscillating signal having a frequency of a desirable wave;
a low-pass filter or a band-pass filter connected to an output stage of the frequency converting portion; and
a detecting portion for detecting a presence/absence of an intermodulation disturbance based on a frequency relationship of a signal output from the low-pass filter or the band-pass filter.

2. The intermodulation disturbance detecting circuit according to claim 1, wherein the frequency converting portion carries out the frequency conversion to output a signal including a sum frequency component of a frequency component of a disturbing wave which is included in the intermediate frequency signal and a frequency component of a desirable wave of the oscillating signal and a difference frequency component therebetween,
the low-pass filter or the band-pass filter attenuates the sum frequency component of the signal output from the frequency converting portion to output a signal of the difference frequency component, and
the detecting portion detects a presence/absence of the intermodulation disturbance based on a frequency relationship of the difference frequency component included in the signal output from the low-pass filter or the band-pass filter.
